(19) United States
(12) Patent Application Publication
(10) Pub. No.: US 2009/0222640 A1
(43) Pub. Date: Sep. 3, 2009

(54) Memory Migration in a Logically Partitioned Computer System

(76) Inventors: Ellen M. Bauman, Rochester, MN (US); Timothy J. Schimke, Stewartville, MN (US); Lee A. Sendelbach, Rochester, MN (US)

Correspondence Address: MARTIN & ASSOCIATES, LLC, P.O. BOX 548, CARTHAGE, MO, 64836-0548, US

(21) Appl. No.: 12/039,392

(22) Filed: Feb. 28, 2008

(51) Int. Cl. G06F 12/06

(52) U.S. Cl. 711/173; 711/E12.084

(57) ABSTRACT

A method and apparatus migrates partition memory in a logically partitioned computer system by utilizing input/output (I/O) space located outside the logical memory blocks (LMBs) to be migrated. The transmit/receive (X/R) queues that are used by network storage adapters and any fixed memory items such as transmit/receive buffers are placed outside the logical memory blocks (LMBs) of the partition. Without the fixed memory items, these LMBs may be migrated without affecting the operation of the network storage adapters or the software in partition memory. The I/O space may be placed outside the partition in a specialized LMB that holds fixed memory items for one or more I/O adapters.

### BACKGROUND

1. Technical Field

This disclosure generally relates to migration and configuration of software in a multi-partition computer system, and more specifically relates to a method and apparatus for migration of memory blocks in a partitioned computer system by utilizing I/O space located outside logical memory blocks of memory to be migrated.

2. Background Art

Computer systems typically include a combination of hardware and software. The combination of hardware and software on a particular computer system defines a computing environment. Different hardware platforms and different operating systems thus provide different computing environments. It was recognized that it is possible to provide different computing environments on the same physical computer system by logically partitioning the computer system resources into different computing environments. The eServer computer system developed by International Business Machines Corporation (IBM) is an example of a computer system that supports logical partitioning. On an eServer computer system, partition managing firmware (referred to as a “hypervisor”) allows defining different computing environments on the same platform. A Hardware Management Console (HMC) provides a user interface to the hypervisor. The hypervisor manages the logical partitions to assure that they can share needed resources in the computer system while maintaining the separate computing environments defined by the logical partitions.

A computer system that includes multiple logical partitions typically shares resources between the logical partitions. For example, a computer system with a single CPU could have two logical partitions defined, with 50% of the CPU allocated to each logical partition, and with the memory and the I/O slots also allocated to the two logical partitions. Each logical partition functions as a separate computer system.

Partition memory is often divided up into logical memory blocks (LMBs). It is desirable to move a LMB with any software and/or data stored in the LMB to another partition. This is often done for system maintenance and load balancing. One particular difficulty with moving LMBs to another partition is the presence of an I/O space or I/O memory pages in the LMB to be moved.

I/O spaces or I/O memory pages are portions of partition memory which are used by network or storage or other I/O adapters that send/receive data. These I/O spaces typically cause the LMB to be non-migratable, which means that the LMB cannot be removed from the space of the partition which owns it and given to a second partition. The memory pages for some Ethernet adapters are not migratable during operation. The adapter must be shut down and restarted to free up the pages so memory migration can occur. Other Ethernet hardware supports migration, but the hardware must be suspended, in order to migrate the send/receive queues.

Current implementations of I/O space in server products make the LMBs non-migratable. Without a way to make I/O space migratable, LMBs in partitioned computer systems will continue to require substantial effort by system administrators to suspend and restart software and hardware during very high bandwidth network operations, which is costly and inefficient.

### BRIEF SUMMARY

The disclosure and claims herein are directed to a method and apparatus for migrating partition memory by utilizing I/O space outside the LMBs to be migrated. The transmit/receive (X/R) queues that are used by network storage adapters and any fixed memory items such as transmit/receive buffers are placed outside the logical memory blocks (LMBs) of the partition. Without the fixed memory items, these LMBs may be migrated without affecting the operation of the network storage adapters or the software in partition memory. The I/O space may be placed outside the partition in a specialized LMB that holds fixed memory items for one or more I/O adapters.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of an apparatus with a memory migration mechanism and an I/O space for efficient migration of the partitioned memory;

FIG. 2 is a block diagram of a prior art partitioned computer system;

FIG. 3 is a block diagram of a prior art partitioned memory for the computer system described with reference to FIG. 2;

FIG. 4 is a block diagram of a partitioned memory with an I/O space as described herein;

FIG. 5 is a block diagram that illustrates how the I/O space is used to hold transmit/receive queues and buffers to allow easy migration of partitioned memory in the computer system as described above with reference to FIG. 4;

FIG. 6 is a block diagram that illustrates how the I/O space can be shared by different partitions;

FIG. 7 is a method flow diagram that illustrates a method for a memory migration mechanism in a partitioned computer system; and

FIG. 8 is another method flow diagram that illustrates a method for a memory migration mechanism in a partitioned computer system.

### DETAILED DESCRIPTION

### 1.0 Overview

The present invention relates to migration of LMBs in logically partitioned computer systems. For those not familiar with the concepts of logical partitions, this Overview section will provide background information that will help to understand the present invention.

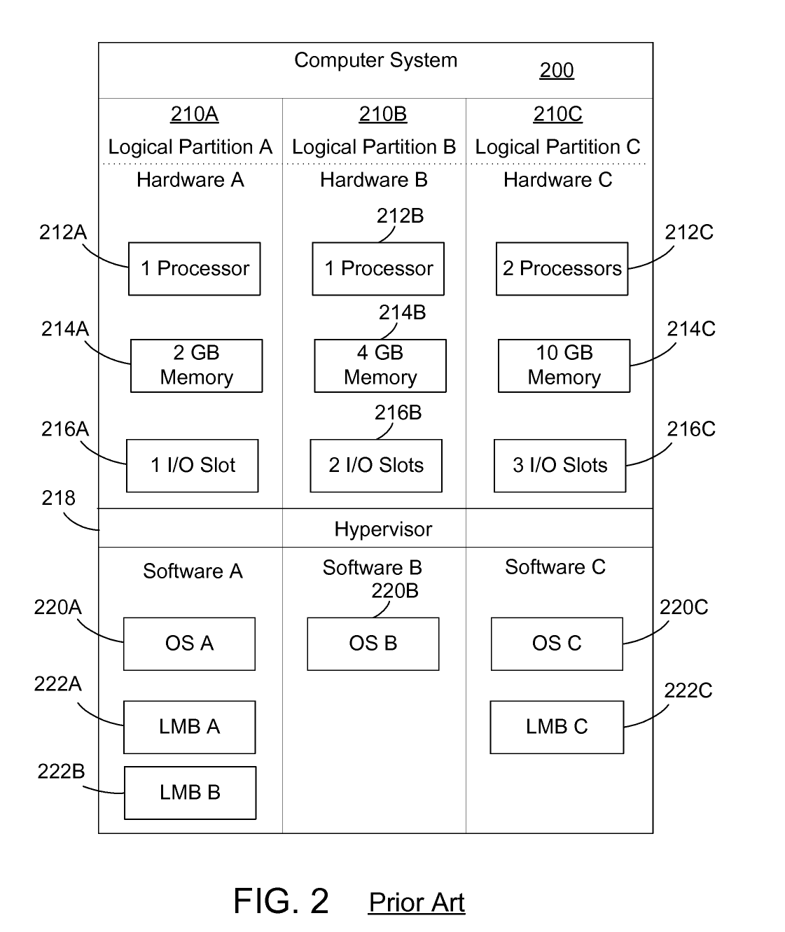

As stated in the Background Art section above, a computer system may be logically partitioned to create multiple virtual machines on a single computer platform. For an example, we assume that we to create a sample computer system to include four processors, 16 GB of main memory, and six I/O slots. Note that there may be many other components inside the sample computer system that are not shown for the purpose of simplifying the discussion herein. We assume that our sample computer system 200 is configured with three logical partitions 210, as shown in FIG. 2. The first logical partition 210A is defined to have one processor 212A, 2 GB of memory 214A, and one I/O slot 216A. The second logical partition 210B is defined to have one processor 212B, 4 GB of memory 214B, and 2 I/O slots 216B. The third logical partition 210C is defined to have two processors 212C, 10 GB of memory 214C, and three I/O slots 216C. Note that the total number of processors 210A+210B+210C equals the four processors in the computer system. Similarly, the memory and I/O slots of the partitions combine to the total number for the system.

A hypervisor (or partition manager) 218 is firmware layer that is required for a partitioned computer to interact with hardware. The hypervisor 218 manages LMBs and the logical partitions to assure that they can share needed resources in the computer system while maintaining the separate computing environments defined by the logical partitions. With hardware resources allocated to the logical partitions, software is installed as shown in FIG. 2. An operating system is installed in each partition, followed by utilities or applications as the specific performance needs of each partition require. The operating systems, utilities and applications are installed in one or more logical memory blocks (LMBs). Thus, for the example in FIG. 2, the first logical partition 210A includes an operating system in a first LMB 220, and two additional LMBs 222A, 222B. The second logical partition 210B includes an operating system LMB 220B. The third logical partition 210C includes an operating system LMB 220C, and another LMB C 222C.

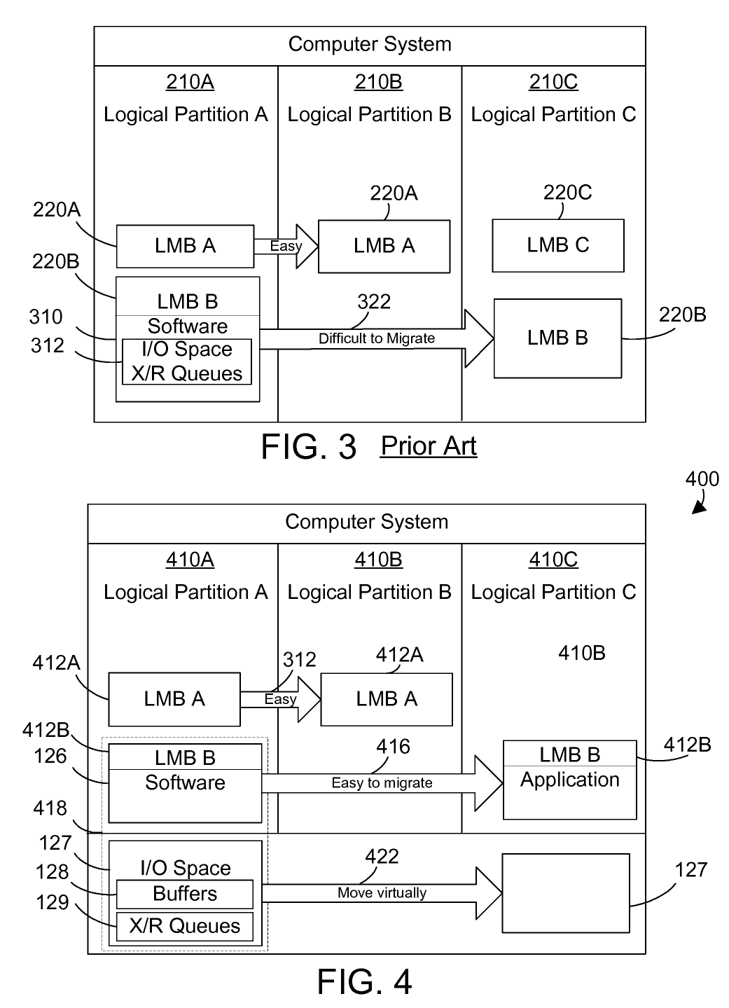

FIG. 3 illustrates additional detail of the LMBs in the logically partitioned computer system described above. As described in the background, there are times when it is desirable to migrate an LMB from one partition to another. For example, LMB A 220A can be migrated from the first logical partition 210A to the second logical partition 210B. Migration of the LMBs is an easy process when the LMB to be moved does not contain memory that must be fixed in a specific location. However, where the LMB B 220B contains software 310 with I/O space 312, and that I/O space contains fixed memory items such as hardware transmit and receive queues, it is difficult to migrate 322 the LMB 220B to a different partition 210C. The specification and claims herein are directed to a method and apparatus to deal with fixed memory items such as hardware transmit and receive queues to efficiently migrate LMBs in a partitioned memory computer system.

### 2.0 Detailed Description

The claims and disclosure herein provide a method and apparatus for migrating partition memory by utilizing I/O space outside the LMBs to be migrated. The transmit/receive (X/R) queues that are used by network storage adapters and any fixed memory items such as transmit/receive buffers are placed outside the partition with the logical memory blocks (LMBs) to be migrated. Without the fixed memory items, these LMBs may be migrated without affecting the operation of the network storage adapters or the software in partition memory.

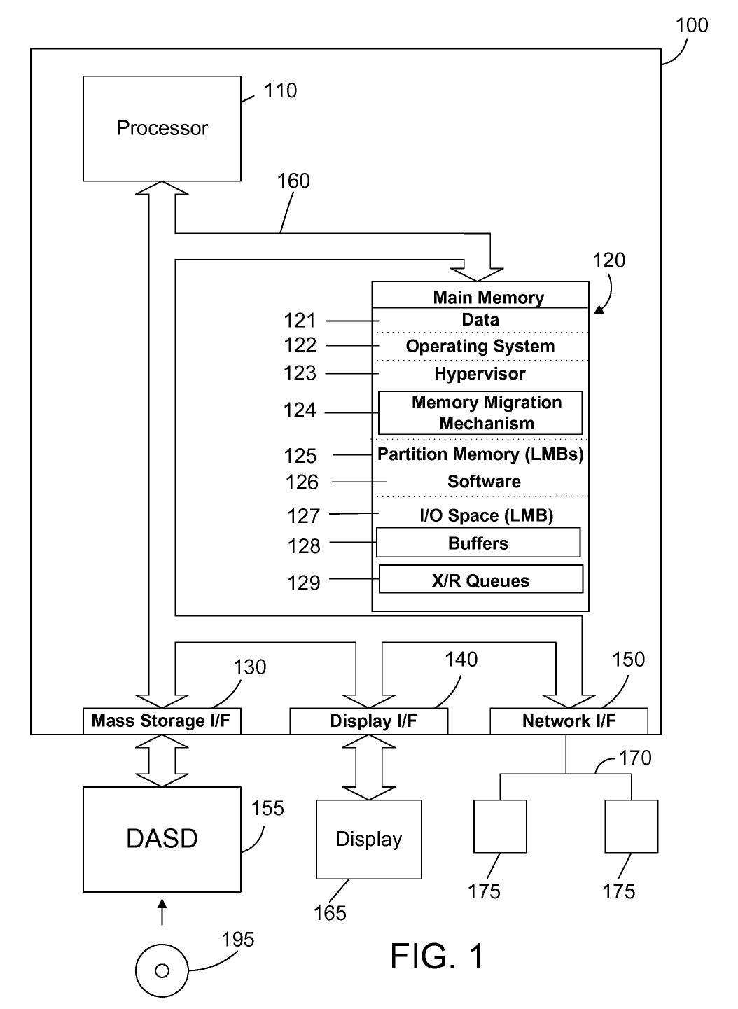

Referring to FIG. 1, a computer system 100 is one suitable implementation of a computer system that includes a memory migration mechanism and I/O space to facilitate efficient migration of LMBs in partitioned memory. Computer system 100 is an IBM eServer computer system. However, those skilled in the art will appreciate that the disclosure herein applies equally to any computer system, regardless of whether the computer system is a complicated multi-user computing apparatus, a single user workstation, or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD-RW drive, which may store data to and read data from a CD-RW 195.

Main memory 120 preferably contains data 121 and an operating system 122. Data 121 represents any data that serves as input to or output from any program in computer system 100. Operating system 122 is a multitasking operating system known in the industry as eServer OS; however, those skilled in the art will appreciate that the spirit and scope of this disclosure is not limited to any one operating system. The memory further includes a hypervisor or partition manager 123 that contains a memory migration mechanism 124, a partition memory 125 with software 126, an I/O space 127 with buffers 128 and transmit/receive queues 129. Each of these entities in memory is described further below.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, hypervisor 123, memory migration mechanism 124, partition memory 125, software 126, I/O space 127, buffers 128, and transmit/receive queues 129 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122.

Although computer system 100 is shown to contain only a single processor and a single system bus, those skilled in the art will appreciate that a memory migration mechanism may be practiced using a computer system that has multiple processors and/or multiple buses. In addition, the interfaces that are used preferably each include separate, fully programmed microprocessors that are used to off-load compute-intensive processing from processor 110. However, those skilled in the art will appreciate that these functions may be performed using I/O adapters as well.

Display interface 140 is used to directly connect one or more displays 165 to computer system 100. These displays 165, which may be non-intelligent (i.e., dumb) terminals or fully programmable workstations, are used to provide system administrators and users the ability to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect computer system 100 to other computer systems or workstations 175 via network 170. Network interface 150 broadly represents any suitable way to interconnect electronic devices, regardless of whether the network 170 comprises present-day analog and/or digital techniques or via some networking mechanism of the future. In addition, many different network protocols can be used to implement a network. These protocols are specialized computer programs that allow computers to communicate across a network. TCP/IP (Transmission Control Protocol/Internet Protocol) is an example of a suitable network protocol.

At this point, it is important to note that while the description above is in the context of a fully functional computer system, those skilled in the art will appreciate that the memory migration mechanism described herein may be distributed as an article of manufacture in a variety of forms, and the claims extend to all suitable types of computer-readable media used to actually carry out the distribution, including recordable media such as floppy disks and CD-RW (e.g., 195 of FIG. 1).

Embodiments herein may also be delivered as part of a service engagement with a client corporation, nonprofit organization, government entity, internal organizational structure, or the like. These embodiments may include configuring a computer system to perform some or all of the methods described herein, and deploying software, hardware, and web services that implement some or all of the methods described herein.

FIG. 4 illustrates a block diagram to illustrate an example of a method and apparatus for migrating partition memory utilizing an I/O space located outside the LMBs to be migrated as described and claimed herein. FIG. 4 represents a portion of a computer system 400 that may include the other features of a partitioned computer system as described above with reference to FIGS. 1 and 2. The computer system 400 is divided into three logical memory partitions 410A, 410B, 410C. Similar to the prior art example above, LMB A 412A can be migrated from the first logical partition 410A to the second logical partition 410B. Migration of this LMB 412A is an easy process since it does not contain memory that must be fixed in a specific location. LMB B 412B contains software 126 where the I/O space 127 associated with the software 126 is located outside the LMB B 412B. The buffers 128 and X/R queues 129 that are associated with this I/O space have been placed in a different memory space as described further below. Thus, in contrast to the prior art, the application 126 that communicates with storage adapters does not contains fixed memory items such as hardware transmit and receive queues. Therefore, the LMB B 412B can be easily migrated 416 to a different partition 410C without the drawbacks in the prior art.

As briefly described above, an I/O space 127 is used to hold the buffers 128 and X/R queues 129 or any other fixed memory items to free the LMBs to be able to migrate freely in partitioned memory space. The I/O space 127 is defined outside the LMBs or at least outside the LMBs that need to be migrated. This means that the I/O space 127 may be a specially designated LMB (I/O space LMB) that is used to hold the buffers 128 and X/R queues 129 and other fixed memory items for one or more applications in one or more LMBs. The designated I/O space LMB could be set up when the system is configured to be an LMB that is a small subset of the total system memory. Further, the I/O space LMB 127 in the example lies outside the logical partition space. As described and claimed herein, the buffers 128, X/R queues 129 and other fixed memory items associated with any software such as operating system device drivers, applications or utilities are stored outside the LMBs in the I/O space 127. Thus, the contents of LMB B 220B as described above with reference to FIG. 3 and the prior art can be considered to be split between the application LMB 412B and the I/O space 127. This frees up the LMB B 412B to be migratable without interruption to the hardware that is using the X/R queues 128 in the I/O space 127 as described more fully below. When LMB B 412B is moved to another location, the corresponding I/O space 127 can stay where it is as shown in FIG. 4, or be moved virtually 422 as described below.

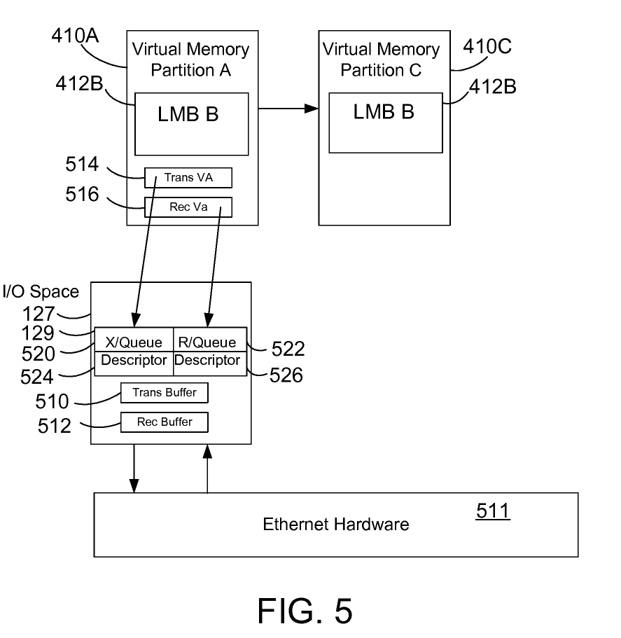

FIG. 5 shows a block diagram that illustrates how the I/O space is used to hold transmit/receive buffers and transmit/receive queues to allow easy migration of partitioned memory in the computer system as described above with reference to FIG. 4. In FIG. 5, LMB A 412B is shown with additional detail to describe the process of migration from the first partition 410A to the second partition 410C. The virtual memory of Partition A 410A has a transmit virtual address (VA) 514 and a receive virtual address 516. The software in LMB B 412B communicates with the I/O space through software variables (not shown) that are mapped to the transmit VA 514 and the receive VA 516. The VAs 514, 516 point to the corresponding XR queues 129 in the I/O space 127. The XR queues 129 comprise a transmit queue 520 and a receive queue 522. The transmit virtual address 514 points to the transmit queue 520 and the receive virtual address 516 points to the receive queue 522. The I/O space 127 also contains a transmit buffer 510 that holds data that is to be sent over the I/O hardware such as the Ethernet Hardware 511. Similarly, a receive buffer 512 holds data received from the Ethernet hardware 511. (Alternatively, the transmit buffer 510 and the receive buffer 512 may reside in the LMB B 412B if they are not addressed directly by I/O hardware). The XR queues 129 each contain one or more descriptors that are placed on the queue by the partition software (not shown) to describe to the Ethernet hardware 511 the location of the data in the transmit buffer 510 and the receive buffer 512. The transmit queue 520 has a transmit descriptor 524 and the receive queue 522 has a receive descriptor 526.

Again referring to FIG. 5, it can be seen that LMB B 412B can be migrated from partition A 410A to Partition C 410C and the virtual addresses 514, 516 that point to the X/R queues 129 will still point to the correct location in the I/O space 127. Thus the LMB can be migrated without affecting the software in the LMB. In addition, the XR queues 129 remain at a fixed location in the I/O space 127 so the Ethernet hardware 511 is not affected by the migration. Thus, the Ethernet hardware does not need to be stopped and restarted as described above for the prior art.

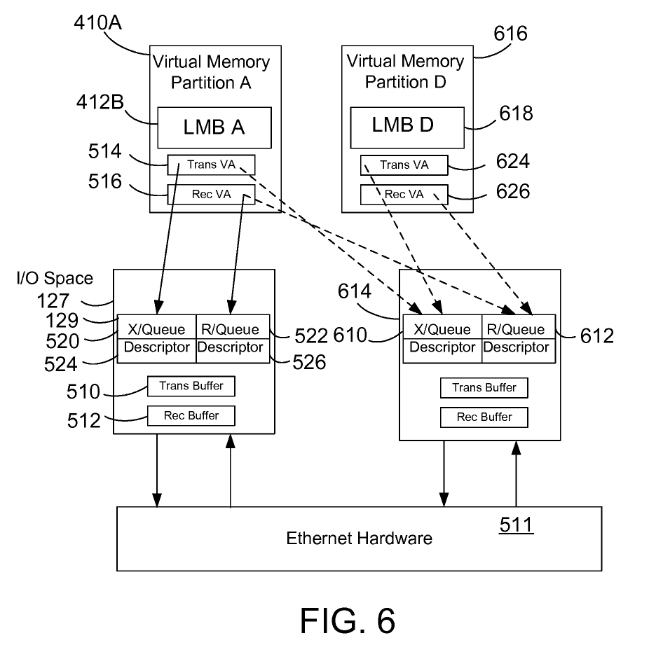

FIG. 6 illustrates how an LMB can be remapped to use different I/O spaces or share I/O spaces with other LMBs in the same or other partitions. In FIG. 6, LMB A 410A communicates with the I/O space 127 as described above, and the common structures have the same reference numbers as described above with reference to FIG. 5. Since the addresses 514, 516 in Partition A 410A are virtual addresses, the I/O space 127 can be moved to a different I/O space simply by changing the real address translation for the addresses corresponding to the transmission VA 514 and the receive VA 516. The address translation can be modified by changing an address look-up table or similar structure as known in the prior art. In the illustrated example, the transmission VA 514 is changed to point to the transmit queue 610 and the receive VA 516 is changed to point to the receive queue 612 in the second I/O space 614.

Again referring to FIG. 6, an additional logical memory block LMB D 616 is able to communicate with the same I/O space 614. LMB D 616 has a transmission VA 624 and a receive VA 626, which function the same as the corresponding structure described above with reference to LMB A 410A. Since the I/O space 614 is outside the partition memory space and addressed with virtual addresses, the application software (not shown) in LMB D 618 can use the I/O space 614 to access the Ethernet hardware 511. This can be done by modifying the address translation of the virtual addresses as described in the previous paragraph to point to the I/O space 614.

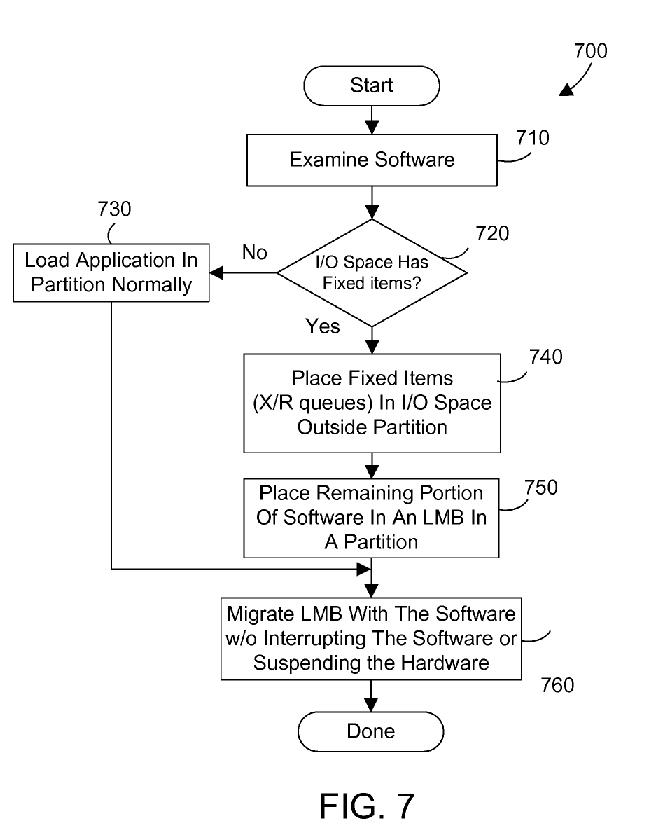

FIG. 7 shows a method 700 for migration of partition memory in a partitioned computer system. The steps in method 700 are preferably performed by the memory migration mechanism 124 in the Hypervisor (partition manager) 123 shown in FIG. 1. First, examine the software (step 710) and determine if there are any fixed items in the I/O space (step 720). If there are no fixed items in the I/O space (step 720=no) then load the software in the partition normally (step 730) and proceed to step 770. If there are fixed items in the I/O space (step 720=yes), then place the fixed items in I/O space outside the partition (step 740). Then place the remaining portion of the software in an LMB in a partition (step 750). Finally, migrate the partition memory with the software without interrupting the software or suspending the hardware associated with the I/O space (step 770). The method is then done.

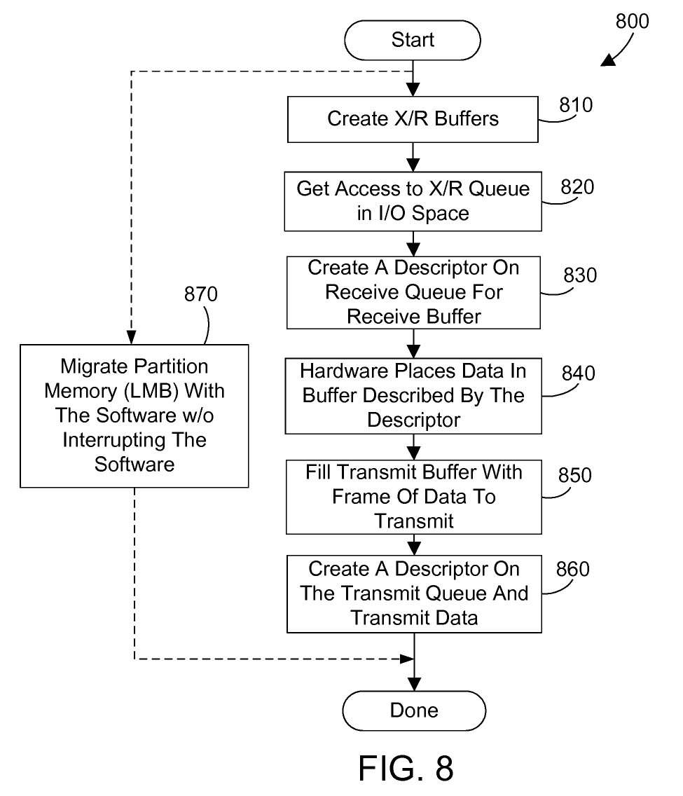

FIG. 8 shows a method 800 for migration of partition memory in a partitioned computer system. Step 870 in method 800 is preferably performed by the memory migration mechanism 124 concurrently with any of steps 810 through 860. Steps 810 through 860 are performed by the application software 126 that is using the I/O space 127 (FIG. 1). First, create transmit and receive buffers in the I/O space (step 810). Then get access to transmit and receive queues in the I/O space (step 820). (Getting access to the transmit and receive queues may include the partition software querying the hypervisor for updated VA address pointers in the I/O space after a memory migration that changed the pointers.) Next, create a descriptor on the receive queue for the receive buffer (step 830). Network hardware then places data in the buffer described in the descriptor (step 840). For transmitting, fill the transmit buffer with a frame of data to transmit (step 850). Create a descriptor on the transmit queue and allow the hardware to transmit data to the transmit buffer using the transmit queue and transmit descriptor (step 860). Migrate the partition LMB containing the software without interrupting the application or the network hardware performing steps 810-860 (step 870). The method is then done.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. An apparatus comprising:
at least one processor in a partitioned computer system;
a memory coupled to the at least one processor;
a plurality of logical partitions on the apparatus designated by a partition manager residing in the memory;
a logical memory block (LMB) with software in a first logical partition;
an input/output (I/O) space that is outside the first logical partition and contains fixed memory items for the software to communicate with hardware; and
a memory migration mechanism that migrates the LMB to a second logical partition without interrupting the hardware.

2. The apparatus of claim 1 wherein the hardware is network communication hardware.

3. The apparatus of claim 1 wherein the I/O space resides in a third LMB that is dedicated to holding one or more I/O spaces for hardware communication.

4. The apparatus of claim 1 wherein the fixed memory items in the I/O space are transmit and receive queues for network hardware.

5. The apparatus of claim 4 wherein the transmit and receive queues contain descriptors that point to transmit and receive buffers to indicate to network hardware where to transmit and receive data.

6. The apparatus of claim 1 wherein the first logical partition includes virtual addresses that point to the transmit and receive queues in the I/O space.

7. A computer-implemented method for migrating partition memory by utilizing input/output (I/O) space, the method comprising the steps of:
(A) examining the I/O space of software for fixed memory items;
(B) removing fixed memory items from the I/O space;
(C) placing a remaining portion of the software in a partition;
(D) placing the fixed memory items in an I/O space outside the partition holding the software; and
(E) migrating the partition memory with the software without interrupting execution of the software.

8. The method of claim 7 wherein the fixed memory items in the I/O space comprise transmit and receive queues for network hardware.

9. The method of claim 8 wherein the I/O space of the application includes virtual addresses that point to the transmit and receive queues in the I/O space.

10. The method of claim 7 further comprising the steps of:
(F) creating transmit and receive buffers in the I/O space;
(G) getting access to the transmit and receive queues;
(H) creating a descriptor in the receive queue for the receive buffer; and
(I) placing received data from the network hardware in the receive buffer described by the descriptor in the receive queue.

11. A method for deploying computing infrastructure, comprising integrating computer readable code into a computing system, wherein the code in combination with the computing system perform the method of claim 7.

12. A computer-implemented method for migrating partition memory by utilizing input/output (I/O) space located outside logical memory blocks (LMBs) to be migrated, the method comprising the steps of:
(A) examining the I/O space of software for fixed memory items;
(B) placing the fixed memory items in an I/O space outside a first logical partition holding the software, wherein the fixed memory items in the I/O space comprise transmit and receive queues for network hardware;
(C) placing a remaining portion of the software in the first logical partition;
(D) creating transmit and receive buffers in the I/O space;
(E) getting access to the transmit and receive queues;
(F) creating a descriptor in the receive queue for the receive buffer;
(G) placing received data from the network hardware in the receive buffer described by the descriptor in the receive queue; and
(H) migrating the partition memory with the software concurrently with steps A-G to migrate the software without interrupting the network hardware.

13. An article of manufacture comprising:
a partition manager with a memory migration mechanism, where the memory migration mechanism performs the steps of:
(A) examining I/O space of software for fixed memory items;
(B) placing the fixed memory items in an I/O space outside a first logical partition holding the software;
(C) placing a remaining portion of the software in a logical memory block (LMB) in the first logical partition; and
computer-readable media bearing the partition manager.

14. The article of manufacture of claim 13 wherein the fixed memory items in the I/O space comprise transmit and receive queues for network hardware to transmit and receive data to transmit and receive buffers in the I/O space.

15. The article of manufacture of claim 13 wherein the I/O space resides in a second LMB that is dedicated to holding one or more I/O spaces for hardware communication.

16. The article of manufacture of claim 13 further comprising the steps of:
(F) creating transmit and receive buffers in the I/O space;
(G) getting access to the transmit and receive queues;
(H) creating a descriptor in the receive queue for the receive buffer; and
(I) placing received data from the network hardware in the receive buffer described by the descriptor in the receive queue.

17. The article of manufacture of claim 16 further comprising the steps of:
(J) filling the transmit buffer with a frame of data to transmit;
(K) creating a descriptor on the transmit queue; and
(L) migrating the LMB with the application to a second partition without interrupting the software and the network hardware.
